(19) United States
(12) Patent Application Publication
(10) Pub. No.: US 2011/0221895 A1
(43) Pub. Date: Sep. 15, 2011

(54) Detection of Movement of a Stationary Video Camera

(76) Inventor: Vinay Sharma, Dallas, TX (US)

(21) Appl. No.: 13/038,120

(22) Filed: Mar. 1, 2011

Related U.S. Application Data
(60) Provisional application No. 61/312,290, filed on Mar. 10, 2010.

(51) Int. Cl. H04N 7/18

(52) U.S. Cl. 348/143; 348/E07.085

(57) ABSTRACT

A method of detecting movement of a video camera is provided that includes computing a reference spatial derivative image from a reference frame, computing a temporal derivative image based on two frames of a video sequence captured by the video camera, and determining whether the video camera has moved based on the number of pixels in the temporal derivative image that match pixels in the reference spatial derivative image.

### CROSS-REFERENCE TO RELATED APPLICATIONS

This application claims benefit of U.S. Provisional Patent Application Ser. No. 61/312,290, filed Mar. 10, 2010, which is incorporated by reference herein in its entirety.

### BACKGROUND OF THE INVENTION

Many video surveillance systems may use stationary video cameras, i.e., cameras that are fixed in place and not intended to move, to provide fixed stationary views of areas of interest. Obviously the efficacy of such systems is adversely affected by tampering with one or more of the cameras. For example, a camera may be deliberately or unintentionally redirected, i.e., moved, to point away from the area of interest and become of limited use for monitoring the area of interest. Further, the movement may adversely affect any algorithms being used to automatically analyze the video from the camera. Accordingly, detection of movement of a stationary camera is important.

### BRIEF DESCRIPTION OF THE DRAWINGS

Particular embodiments in accordance with the invention will now be described, by way of example only, and with reference to the accompanying drawings:

FIG. 1 shows a block diagram of a surveillance system in accordance with one or more embodiments of the invention;

FIG. 2 shows a block diagram of a video camera in accordance with one or more embodiments of the invention;

FIG. 3 shows a block diagram of a computer system in accordance with one or more embodiments of the invention;

FIGS. 4 and 5 show flow diagrams of methods in accordance with one or more embodiments of the invention; and

FIG. 6 shows an illustrative embedded digital system in accordance with one or more embodiments of the invention.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency.

Certain terms are used throughout the following description and the claims to refer to particular system components. As one skilled in the art will appreciate, components in digital systems may be referred to by different names and/or may be combined in ways not shown herein without departing from the described functionality. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” and derivatives thereof are intended to mean an indirect, direct, optical, and/or wireless electrical connection. Thus, if a first device couples to a second device, that connection may be through a direct electrical connection, through an indirect electrical connection via other devices and connections, through an optical electrical connection, and/or through a wireless electrical connection.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail and/or shown to avoid unnecessarily complicating the description. In addition, although method steps may be presented and described herein in a sequential fashion, one or more of the steps shown and described may be omitted, repeated, performed concurrently, and/or performed in a different order than the order shown in the figures and/or described herein. Accordingly, embodiments of the invention should not be considered limited to the specific ordering of steps shown in the figures and/or described herein. In addition, for convenience in describing embodiments of the invention, the term frame may be used to refer to the portion of a video sequence being processed. One of ordinary skill in the art will understand embodiments of the invention that operate on subsets of frames such as, for example, a slice, a field, a video object plane, a picture, etc.

In general, embodiments of the invention provide for detection of movement of a stationary video camera. More specifically, in embodiments of the invention, the edges, i.e., the spatial derivative, of a reference frame of the scene being monitored by a video camera are compared with the inter-frame difference, i.e., temporal derivatives, of successive frames of the scene captured by the video camera. The spatial derivative image may be computed as a spatial binary image in which the edge pixels are “on”, e.g., set to 1, and the remaining pixels are “off”, e.g., set to 0. The temporal derivative image may be computed as a temporal binary image in which on pixels indicate significant change in the pixel values between corresponding pixels in two frames and off pixels indicate no change or insignificant change in the pixel values between corresponding pixels in the two frames. Note that if the video camera does not move and there is no activity in the frames, most, if not all, pixels in the temporal binary image will be off.

A high degree of match, i.e., a sufficiently large number of matching on pixels, between the spatial derivative image and a temporal derivative image indicates motion in the scene, which implies that the video camera has been moved. The degree of match may be determined by computing a match score based on a comparison of the on pixels in a spatial binary image computed from the spatial derivative image and the on pixels in a temporal binary image computed from the temporal derivative image. In some embodiments of the invention, the match score is computed as a function of recall, i.e., true positive rate, precision, and the F measure of recall and precision. If the match score indicates a high degree of match, movement is detected and a notification may then be generated regarding the detected movement.

In some embodiments of the invention, once movement is detected, the cessation of movement is also detected. More specifically, when movement is detected, the number of on pixels in the temporal binary image at the time the movement is detected is remembered. For subsequent frames, temporal derivatives for these frames are computed and the number of on pixels is counted. It is expected that while the video camera is in motion, the number of on pixels will increase from frame to frame until a peak number is reached and then begin decreasing as the camera movement comes to a stop. When the number of on pixels in a temporal binary image is similar to the counted number of on pixels from the original temporal binary image, cessation of movement is detected. The period of time between the movement detection and the detected cessation of movement is the period of motion. A notification may then be generated regarding the cessation of movement.

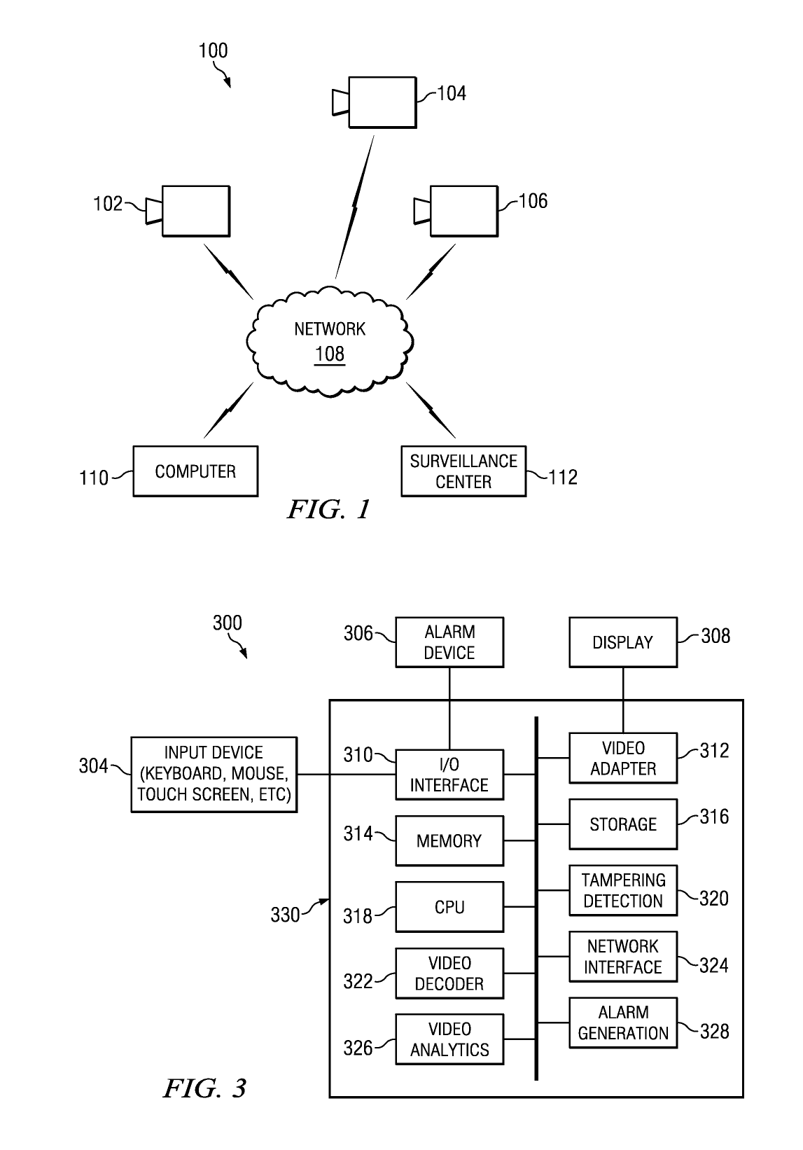

FIG. 1 shows a block diagram of a surveillance network (100) in accordance with one or more embodiments of the invention. The surveillance network (100) includes three surveillance cameras (102, 104, 106), and three monitoring systems (110, 112) connected via a network (108). The network (108) may be any communication medium, or combination of communication media suitable for transmission of video sequences captured by the surveillance cameras (102, 104, 106), such as, for example, wired or wireless communication media, a local area network, or a wide area network.

Three surveillance cameras are shown for illustrative purposes. More or few surveillance cameras may be used in embodiments of the invention. Further, the surveillance cameras may be digital video cameras, analog video cameras, or a combination thereof. The surveillance cameras (102, 104, 108) may be stationary, may pan a surveilled area, or a combination thereof. The surveillance cameras may include functionality for encoding and transmitting video sequences to a monitoring system (110, 112) or may be connected to a system (not specifically shown) that provides the encoding and/or transmission. For analog video cameras, the analog signal is converted to a digital signal and encoded prior to transmission. Although not specifically shown, in some embodiments of the invention, one or more of the surveillance cameras (102, 104, 106) may be directly connected to a monitoring system (110, 112) via a wired interface instead of via the network (108).

Different monitoring systems (110, 112) are shown to provide examples of the types of systems that may be connected to surveillance cameras. One or ordinary skill in the art will know that the surveillance cameras in a network do not necessarily communicate with all monitoring systems in the network. Rather, each surveillance camera will likely be communicatively coupled with a specific computer (110) or surveillance center (112).

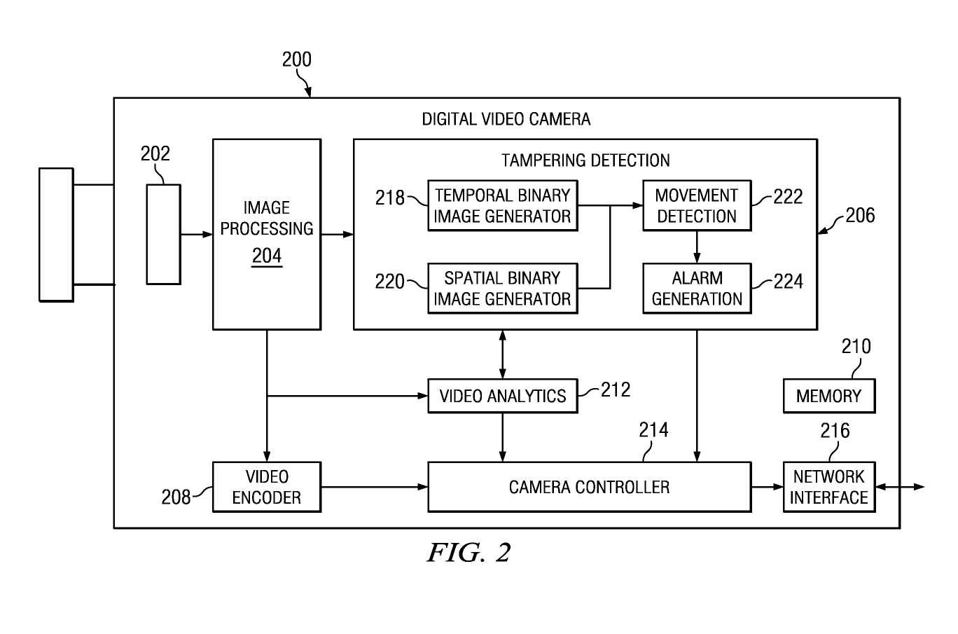

In one or more embodiments of the invention, the surveillance network (100) includes functionality to detect when a stationary surveillance camera (102, 104, 106) is moved. For illustrative purposes only, the surveillance network (100) will be described as if all the surveillance cameras (102, 104, 106) are stationary. In some such embodiments, the surveillance network (100) is also configured to detect when the movement of a stationary surveillance camera stops. Movement detection and detection of cessation of movement is described in more detail below in reference to FIGS. 2-4. The movement detection and the detection of cessation of movement, when provided, may be performed in a suitably configured surveillance camera, or in a suitably configured computer in the surveillance center (112) that is receiving the encoded video sequence from a stationary surveillance camera or in a computer (110). The movement detection and the detection of cessation of movement, when provided, may also be provided by a system (not specifically shown) connected to a surveillance camera that provides the encoding and/or transmission of the video sequence captured by the surveillance camera.

The surveillance center (112) includes one or more computer systems and other equipment for receiving and displaying the video sequences captured by the surveillance cameras communicatively coupled to the surveillance center (112). The computer systems may be monitored by security personnel and at least one of the computer systems may be configured to generate audible and/or visual alarms when movement of a stationary surveillance camera is detected. In some embodiments of the invention, a computer system receiving a video sequence from a stationary surveillance camera may be configured to respond to detected movement of the stationary surveillance camera by calling security personnel, sending a text message or the like, or otherwise transmitting an indication of the detected movement to security personnel.

The computer (110) is configured to receive video sequence(s) from one or more video surveillance cameras. Such a combination of a computer and one or more video surveillance cameras may be used, for example, in a home security system, a security system for a small business, etc. Similar to computers in a surveillance center, the computer (110) may be configured to generate audible and/or visual alarms and/or notifying a security monitoring service or the home/business owner via a text message, a phone call, or the like when movement of a stationary surveillance camera is detected.

FIG. 2 is a block diagram of a digital video camera (200) in accordance with one or more embodiments of the invention. The digital video camera (200) may be used in a surveillance network (100). The digital video camera includes an image sensor (202), an image processing component (204), a video encoder component (208), a memory component (210), a tampering detection component (206), a video analytics component (212), a camera controller (214), and a network interface (216). The components of the digital video camera (200) may be implemented in any suitable combination of software, firmware, and hardware, such as, for example, one or more digital signal processors (DSPs), microprocessors, discrete logic, application specific integrated circuits (ASICs), field-programmable gate arrays (FPGAs), etc. Further, software instructions may be stored in memory in the memory component (210) and executed by one or more processors.

The imaging sensor (202), e.g., a CMOS sensor, a CCD sensor, etc., converts optical images to analog signals. These analog signals are converted to digital signals and provided to the image processing component (204).

The image processing component (204) divides the incoming digital signal into frames of pixels and processes each frame to enhance the image in the frame. The processing performed may include one or more image enhancement techniques. For example, the image processing component (204) may perform one or more of black clamping, fault pixel correction, color filter array (CFA) interpolation, gamma correction, white balancing, color space conversion, edge enhancement, detection of the quality of the lens focus for auto focusing, and detection of average scene brightness for auto exposure adjustment. The processed frames are provided to the video encoder component (208), the video analytics component (212), and the tampering detection component (206).

The video encoder component (208) encodes the processed frames in accordance with a video compression standard such as, for example, the Moving Picture Experts Group (MPEG) video compression standards, e.g., MPEG-1, MPEG-2, and MPEG-4, the ITU-T video compressions standards, e.g., H.263 and H.264, the Society of Motion Picture and Television Engineers (SMPTE) 421 M video CODEC standard (commonly referred to as “VC-1”), the video compression standard defined by the Audio Video Coding Standard Workgroup of China (commonly referred to as “AVS”), ITU-T/ISO High Efficiency Video Coding (HEVC) standard, etc.

The memory component (210) may be on-chip memory, external memory, or a combination thereof. Any suitable memory design may be used. For example, the memory component (210) may include static random access memory (SRAM), dynamic random access memory (DRAM), synchronous DRAM (SDRAM), read-only memory (ROM), flash memory, a combination thereof, or the like. Various components in the digital video camera (200) may store information in memory in the memory component (210) as a video stream is processed. For example, the video encoder component (208) may store reference data in a memory of the memory component (210) for use in encoding frames in the video stream. In one or more embodiments of the invention, the memory component (210) stores software instructions that, when executed by a processor, cause the digital video camera (200) to monitor one or more stationary surveillance cameras to detect movement. In some such embodiments, the memory component (210) also stores software instructions that, when executed by the processor, cause the digital video camera (200) to detect cessation of detected movement.

The software instructions may be initially stored in a computer-readable medium such as a compact disc (CD), a diskette, a tape, a file, memory, or any other computer readable storage device and loaded and stored on the digital video camera (200). In some cases, the software instructions may also be sold in a computer program product, which includes the computer-readable medium and packaging materials for the computer-readable medium. In some cases, the software instructions may be distributed to the digital video camera (200) via removable computer readable media (e.g., floppy disk, optical disk, flash memory, USB key), via a transmission path from computer readable media on another computer system (e.g., a server), etc.

The camera controller component (214) controls the overall functioning of the digital video camera (200). For example, the camera controller component (214) may adjust the focus and/or exposure of the digital video camera (214) based on the focus quality and scene brightness, respectively, determined by the image processing component (204). The camera controller component (214) also controls the transmission of the encoded video stream via the network interface component (216) and may control reception and response to camera control information received via the network interface component (216). Further, the camera controller component (214) controls the transfer of alarms from the tampering detection component (206) and the transfer of alarms and other information from the video analytics component (212) (when the video analytics component is configured to generate date and/or alarms for transmission) via the network interface component (216).

The network interface component (216) allows the digital video camera (200) to communicate with a monitoring system. The network interface component (216) may provide an interface for a wired connection, e.g., an Ethernet cable or the like, and/or for a wireless connection. The network interface component (216) may use any suitable network protocol(s).

The video analytics component (212) analyzes the content of frames of the captured video stream to detect and determine temporal events not based on a single frame. The analysis capabilities of the video analytics component (212) may vary in embodiments of the invention depending on such factors as the processing capability of the digital video camera (200), the particular application for which the digital video camera is being used, etc. For example, the analysis capabilities may range from video motion detection in which motion is detected with respect to a fixed background model to people counting, detection of objects crossing lines or areas of interest, vehicle license plate recognition, object tracking, facial recognition, automatically analyzing and tagging suspicious objects in a scene, activating alarms or taking other actions to alert security personnel, etc.

In some embodiments of the invention, the video analytics component (212) generates and maintains a background model of a scene under surveillance to be used in the analysis of the incoming video frames. Any suitable technique for building and maintaining background models may be used. For example, a simple technique for generating a background model is to initially capture a single frame of the scene that will be used for the background model, and then to update the background model periodically by capturing another frame to replace the previous one. In another example, a Gaussian background model may be used that continuously updates the background model from the frames. In essence, the intensity values of each pixel in the frames of the video sequence are tracked over time and modeled using a Gaussian function. The background model is maintained as a frame of the modeled, i.e., typical pixel intensity values, of each pixel. In one or more embodiments of the invention, the video analytics component (212) provides the background model to the tampering detection component (206), e.g., stores it in a memory of the memory component (210) accessible by the tampering detection component (206). The video analytics component (210) may also notify the tampering detection component (206) when the background model is updated.

The tampering detection component (206) includes functionality to detect when the digital video camera (200) is moved from a fixed location. In some embodiments of the invention, the tampering detection component (206) also includes functionality to detect when the digital video camera (200) stops moving after movement is detected. The tamper detection component (206) includes a spatial binary image generator component (220), a temporal binary image generator (218), a movement detection component (222), and an alarm generation component (224).

The spatial binary image generator component (220) generates and updates a spatial binary image, i.e., a reference binary image, for use by the movement detection component (222). The spatial binary image is a binary image generated by performing edge detection on a reference frame of the video sequence. A reference frame is a frame that is representative the scene being monitored by the digital video camera (200) in its fixed position. The reference frame, and the reference binary image, may be updated at a suitable rate depending on factors such as level of scene activity, available MHz, etc.

An edge is defined as a discontinuity in pixel intensity within an image. For example, in gray-scale images, an edge is an abrupt gray-level change between neighboring pixels. By highlighting the most predominant discontinuities, edge detection can reveal boundaries between regions of contrasting image intensity. Essentially, edge detection is like running a spatial derivative filter over an image. The simplest derivative filter could be a +1/−1 filter in which each left pixel in a frame is subtracted from the right pixel and the result stored.

The spatial binary image generator component (220) may use any suitable edge detection technique that produces a binary image in which edge pixels are on and the remaining pixels are off. In some embodiments of the invention, to perform edge detection on a reference frame, the spatial binary image generator component (220) computes the x and y derivatives of the reference frame and obtains a reference binary image by comparing the gradient magnitudes against a threshold. That is, the spatial binary image generator component (220) filters the reference frame using a 2D gradient filter to measure the horizontal and vertical gradients at each pixel in the frame. The resulting filtered image is then processed to generate an edge map in which all pixels whose edge strength is not a local maximum along the gradient, i.e., edge, direction are suppressed. The output of this non-maximum suppression process is an edge map in which pixels that are not suppressed are set to a non-zero value, and the suppressed pixels are off.

Finally, hysteresis thresholding is performed to link stronger edge segments connected to weaker edge segments to form continuous edges. The hysteresis thresholding applies two thresholds to the pixels that have not been suppressed, i.e., possible edges. If the pixel's gradient magnitude is below the lower threshold, the pixel is designated a non-edge pixel and is turned off in the output image. If the gradient magnitude is above the higher threshold, the pixel designated as an edge pixel and is turned on in the output image. If the magnitude of a pixel is between the two thresholds, then the pixel is designated an edge pixel and turned on in the output image if there is a path from the pixel to a pixel with a gradient above the higher threshold. Otherwise, the pixel is designated as a non-edge pixel and is turned off in the output image. The output of this process is a reference binary image in which the identified edge pixels are on and the remaining pixels are off. Some embodiments of this edge detection technique are described in more detail in U.S. patent application Ser. No. 12/572,704, filed on Oct. 10, 2009.

In some embodiments of the invention, the spatial binary image generator (220) selects an initial reference frame from frames captured by the digital video camera (200) when the digital video camera (200) is initialized. An initial reference binary image is then generated from the initial reference frame. The spatial binary image generator (220) then updates the reference binary image periodically, e.g., at predetermined time intervals, by selecting a new reference frame from the frames being generated by the image processing component (204) and generating a new reference binary image from that reference frame.

In some embodiments of the invention, the spatial binary image generator (220) uses the background model generated by the video analytics component (212) as the reference frame. That is, when the digital video camera (200) is initialized, the video analytics component (212) generated an initial background model. The binary image generator (220) then accesses this initial background model and uses it as the reference frame to generate the initial reference binary image. In some such embodiments, the spatial binary image generator (220) then updates the reference binary image periodically, e.g., at predetermined time intervals, by again access the background model maintained by the video analytics component (212). In other such embodiments, the spatial binary image generator (220) updates the reference binary image from the background model when notified by the video analytics component (212) that the background model has changed.

The temporal binary image generator component (218) generates temporal binary images from frames produced by the image processing component for use by the movement detection component (222). A temporal binary image is the temporal derivative between two successive incoming frames. The temporal binary image generator component (218) generates a temporal binary image between two successive frames by computing the pixel by pixel difference between the two frames and applying a threshold to the resulting pixel differences to produce a binary image in which pixels having a sufficiently large pixel difference are turned on and the remaining pixels are turned off.

More specifically, the temporal binary image generator component (210) may generate a temporal binary image as follows. For each pixel in a frame J at time t, i.e., the current frame, compute the pixel difference between that pixel and a corresponding pixel in a frame I at time t−1, i.e., the previous frame, compute

T_{d}(x,y)=abs(J(x,y)−I(x,y))

where x and y are the pixel coordinates, and T_{d} is the output image, i.e., a temporal derivative image. A threshold is then applied to each pixel in the temporal derivative image T_{d} to generate the temporal binary image T as follows:

T(x,y)=0, if T_{d}(x,y)<D1

T(x,y)=1, if T_{d}(x,y)>=D1

The threshold D1 may be determined empirically. In many surveillance systems, the user sets a single parameter (or knob) that controls how sensitive the underlying algorithms are. In some embodiments of the invention, the threshold D1 and other thresholds are adjusted based on based on this sensitivity parameter. For example, the range of sensitivity values s may be between 1 and 5. The threshold D1 may then be determined as follows:

D1=10*(6−s).

In some such embodiments, the default value of s is 3 and the default value of D1 is 30, and may vary between 10 and 50.

The movement detection component (222) compares each temporal binary image generated by the temporal binary image generator (218) to the reference binary image generated by the spatial binary image generator (220) to determine if the digital video camera (200) has been moved. A key observation that underlies this comparison is that if the digital video camera (200) is moved at time t, and a temporal derivative is computed between the frame at time t and the frame at time t−1, the on pixels in the temporal binary image, i.e., those pixels in the frame at time t with the largest temporal derivative, likely correspond to on pixels, i.e., edges detected from the spatial derivative of the reference frame, in the spatial binary image. Accordingly, the movement detection component (222) compares the temporal binary image to the spatial binary image looking for a pixel-wise match of on pixels between the two binary images.

The movement detection component (222) then generates a match score based on the number of matching on pixels. The match score may be computed using any suitable scoring technique that measures the accuracy of the match between the two images. Based on this match score, the movement detection component (222) determined whether or not the digital video camera (200) has moved. If the determination is made that the camera has moved, the movement detection component (222) signals the movement to the alarm generation component (224).

The determination of the match score may be viewed as a classification problem with two classes, the actual positive cases, i.e., the on pixels in the spatial binary image, and the predicted positive cases, i.e., the on pixels in the temporal binary image. Accordingly, the match score can be computed using any of a number of standard metrics such as, for example, the well-known F-measure which is a measure of accuracy of a test. Note that other techniques for scoring the match between the two binary images may also be used. In general, an F-measure score considers both the precision P and the recall R (true positive rate). The precision P is the number of correct results divided by the number of all returned results and the recall R is the number of correct results divided by the number of results that should have been returned. The F-measure is defined as 2PR/P+R. The higher the F-measure, the more accurate the match.

In some embodiments of the invention, the movement detection component (222) computes an F-measure as the match score and compares the match score to a match threshold value. The match threshold may be empirically determined and, similar the threshold used in generation of the temporal binary image, may be adjusted based on a sensitivity value. If the match score exceeds the match threshold, the movement detection component (222) indicates to the alarm generation component (224) that the digital video camera (200) has moved. In such embodiments, the total number of on pixels X in the temporal binary image, the total number of on pixels Y in the spatial binary image, and the number of on pixels Z that match between the two images are determined. The precision P is then computed as Z/X and the recall R is computed as Z/Y. For example, assume that there are 200 on pixels in the temporal binary image, 100 on pixels in the spatial binary image, and a total of 80 of the on pixels match. The precision P=80/200=0.4 and the recall R=80/100=0.8. The F-measure=2×0.4×8/0.4+0.8=0.64/1.2=0.53.

In some embodiments of the invention, the movement detection component (222) computes the match score as a function of the recall R, the precision P, and the F-measure. In such embodiments, each of the values is compared to respective threshold values, and a match score is determined from the results of these comparisons. The match score may be determined, for example, using a voting scheme that considers the outcomes of the comparisons. For example, if two of the three comparisons indicate movement, then the camera is determined to have moved. The voting scheme could also be weighted.

In one or more embodiments of the invention, the movement detection component (222) also determines when the digital video camera (200) stops moving. In such embodiments, when movement is detected, the movement detection component (222) stores the number of on pixels X in the temporal binary image that triggered the detection of the movement. Then, for each subsequent frame, the movement detection component counts the number of on pixels S in that frame and compares S to X. When S<X, the movement detection component (222) signals the cessation of movement of the digital video camera (200) to the alarm generation component (224). The movement detection component (222) may also count the number of frames between the detection of movement and the cessation of movement so that the duration of movement can be determined.

The alarm generation component (224) generates an alarm signal indicating camera movement when the movement detection component (222) signals that movement of the digital video camera (200) has been detected and provides the alarm signal to the camera controller for transmission to a monitoring system. In some embodiments of the invention, the alarm generation component (224) may also provide this alarm signal to the video analytics component (212). In embodiments of the invention in which the movement detection component (222) also detects cessation of the movement, the alarm generation component (224) also generates an alarm signal indicating cessation of camera movement and provides this alarm signal to the cameral controller for transmission to a monitoring system. The alarm generation component (224) may also provide the frame count between the detection and cessation of movement and/or the duration of the movement with the alarm signal. In some such embodiments, the alarm generation component (224) also provides this alarm signal to the video analytics component (212).

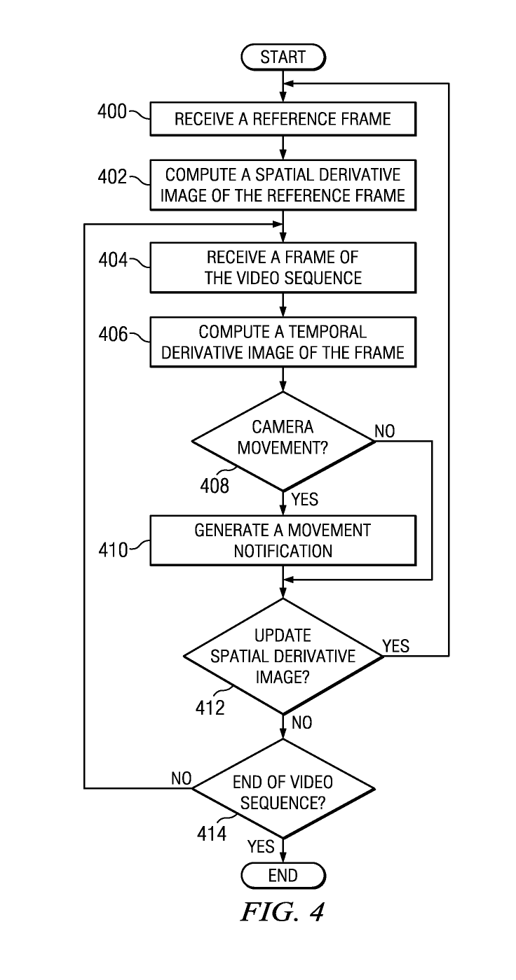

FIG. 3 is a block diagram of a computer system (300) in accordance with one or more embodiments of the invention. The computer system (300) may be used in a surveillance network (100) as, for example, the computer system (110) or as a computer system in the surveillance center (112). The computer system (300) includes a processing unit (330) equipped with one or more input devices (304) (e.g., a mouse, a keyboard, or the like), and one or more output devices, such as a display (308), or the like. In some embodiments of the invention, the computer system (300) also includes an alarm device (306). In some embodiments of the invention, the display (308) may be touch screen, thus allowing the display (308) to also function as an input device. The processing unit (330) may be, for example, a desktop computer, a workstation, a laptop computer, a dedicated unit customized for a particular application, or the like. The display may be any suitable visual display unit such as, for example, a computer monitor, an LED, LCD, or plasma display, a television, a high definition television, or a combination thereof.

The processing unit (330) includes a central processing unit (CPU) (318), memory (314), a storage device (316), a video adapter (312), an I/O interface (310), a video decoder (322), and a network interface (324) connected to a bus. In some embodiments of the invention, the processing unit (330) may include one or more of a video analytics component (326), an alarm generation component (328), and a tampering detection component (320) connected to the bus. The bus may be one or more of any type of several bus architectures including a memory bus or memory controller, a peripheral bus, video bus, or the like.

The CPU (318) may be any type of electronic data processor. For example, the CPU (318) may be a processor from Intel Corp., a processor from Advanced Micro Devices, Inc., a Reduced Instruction Set Computer (RISC), an Application-Specific Integrated Circuit (ASIC), or the like. The memory (314) may be any type of system memory such as static random access memory (SRAM), dynamic random access memory (DRAM), synchronous DRAM (SDRAM), read-only memory (ROM), flash memory, a combination thereof, or the like. Further, the memory (314) may include ROM for use at boot-up, and DRAM for data storage for use while executing programs.

The storage device (316) (e.g., a computer readable medium) may comprise any type of storage device configured to store data, programs, and other information and to make the data, programs, and other information accessible via the bus. In one or more embodiments of the invention, the storage device (316) stores software instructions that, when executed by the CPU (318), cause the processing unit (330) to monitor one or more stationary digital video cameras being used for surveillance to detect movement of any of those cameras. In some such embodiments, the storage device (316) also stores software instructions that, when executed by the CPU (318), cause the processing unit (330) to detect cessation of detected movement. The storage device (316) may be, for example, one or more of a hard disk drive, a magnetic disk drive, an optical disk drive, or the like.

The software instructions may be initially stored in a computer-readable medium such as a compact disc (CD), a diskette, a tape, a file, memory, or any other computer readable storage device and loaded and executed by the CPU (318). In some cases, the software instructions may also be sold in a computer program product, which includes the computer-readable medium and packaging materials for the computer-readable medium. In some cases, the software instructions may be distributed to the computer system (300) via removable computer readable media (e.g., floppy disk, optical disk, flash memory, USB key), via a transmission path from computer readable media on another computer system (e.g., a server), etc.

The video adapter (312) and the I/O interface (310) provide interfaces to couple external input and output devices to the processing unit (330). As illustrated in FIG. 3, examples of input and output devices include the display (308) coupled to the video adapter (312) and the mouse/keyboard (304) and the alarm device (306) coupled to the I/O interface (310).

The network interface (324) allows the processing unit (330) to communicate with remote units via a network (not shown). In one or more embodiments of the invention, the network interface (324) allows the computer system (300) to communicate via a network to one or more digital video cameras to receive encoded video sequences and other information transmitted by the digital video camera(s). The network interface (324) may provide an interface for a wired link, such as an Ethernet cable or the like, and/or a wireless link via, for example, a local area network (LAN), a wide area network (WAN) such as the Internet, a cellular network, any other similar type of network and/or any combination thereof.

The computer system (110) may also include other components not specifically shown. For example, the computer system (110) may include power supplies, cables, a motherboard, removable storage media, cases, and the like.

The video decoder component (322) decodes frames in an encoded video sequence received from a digital video camera in accordance with a video compression standard such as, for example, the Moving Picture Experts Group (MPEG) video compression standards, e.g., MPEG-1, MPEG-2, and MPEG-4, the ITU-T video compressions standards, e.g., H.263 and H.264, the Society of Motion Picture and Television Engineers (SMPTE) 421 M video CODEC standard (commonly referred to as “VC-1”), the video compression standard defined by the Audio Video Coding Standard Workgroup of China (commonly referred to as “AVS”), ITU-T/ISO High Efficiency Video Coding (HEVC) standard, etc. The decoded frames may be provided to the video adapter (312) for display on the display (308). In embodiments of the invention including the video analytics component (326) and/or the tampering detection component (320), the video decoder component (322) provides the decoded frames to these components.

In some embodiments of the invention, the video decoder component (322) also decodes any additional data transmitted by a digital video camera and provides that data to the appropriate component in the processing unit (330). For example, if the digital video camera performs movement detection as described herein, the camera may transmit a signal to the computer system (300), i.e., a movement alarm signal, indicating that the camera has moved. In such cases, the video decoder component (322) provides the movement alarm signal to the alarm generation component (328).

The video analytics component (326) analyzes the content of frames of the captured video stream to detect and determine temporal events not based on a single frame. The analysis capabilities of the video analytics component (326) may vary in embodiments of the invention depending on such factors as the processing capability of the processing unit (330), the processing capability of digital video cameras transmitting encoded video sequences to the computer system (300), the particular application for which the digital video cameras are being used, etc. For example, the analysis capabilities may range from video motion detection in which motion is detected with respect to a fixed background model to people counting, detection of objects crossing lines or areas of interest, vehicle license plate recognition, object tracking, facial recognition, automatically analyzing and tagging suspicious objects in a scene, activating alarms or taking other actions to alert security personnel, etc.

In some embodiments of the invention, the video analytics component (326) generates and maintains background models of scenes under surveillance by the digital video cameras to be used in the analysis of the incoming video frames from those cameras. Any suitable technique for building and maintaining background models may be used such as those previously described herein.

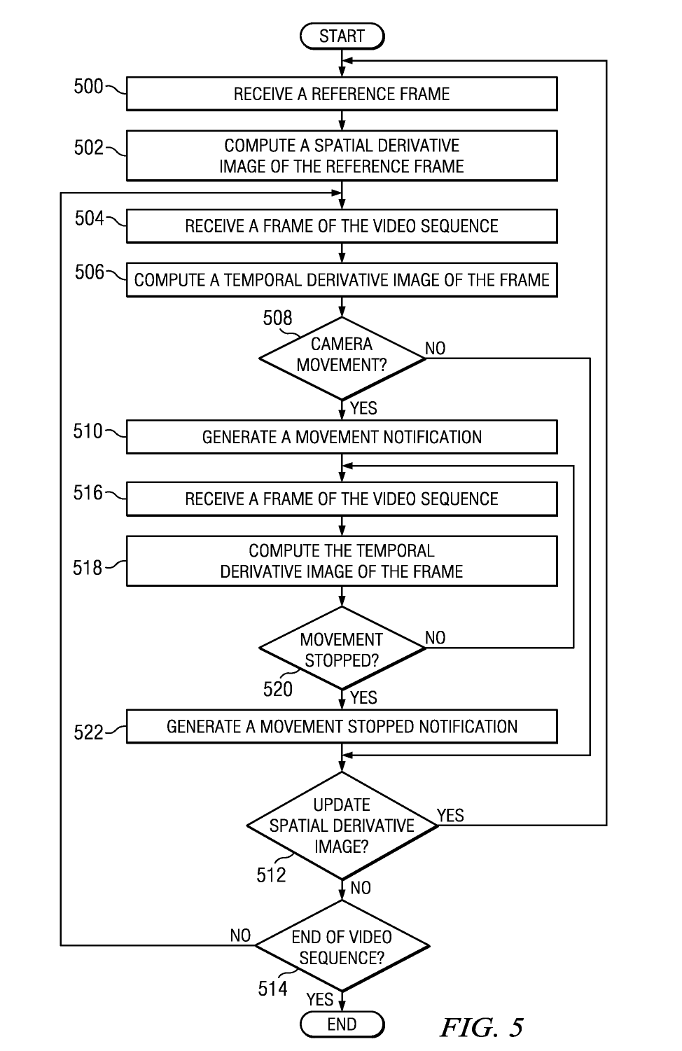

The tampering detection component (320) includes functionality to detect when a digital video camera is moved from a fixed location. In some embodiments of the invention, the tampering detection component (320) also includes functionality to detect when the digital video camera stops moving after movement is detected. In some embodiments of the invention, the tampering detection component (320) includes functionality to perform the method of FIG. 4 or FIG. 5. In one or more embodiments of the invention, the tamper detection component (320) includes components to perform the movement detection as previously described herein in reference to the tamper detection component (206) of FIG. 2. In some such embodiments, the tamper detection component (320) also includes components to perform the detection of cessation of the movement as previously described herein in reference to the tamper detection component (206) of FIG. 2. The tamper detection component (320) may include an alarm generation component as previously described or may send any signals regarding movement detection and cessation of movement to the alarm generation component (326).

The alarm generation component (326) may receive alarm signals from the video decoder component (322), the tampering detection component (320) and/or the video analytics component (326) and performs actions to notify monitoring personnel of the alarm. The actions to be taken may be user-configurable and may differ according to the type of the alarm signal. For example, the alarm generation component (328) may cause a visual cue to be displayed on the display (308) for less critical alarms and may generate an audio and/or visual alarm via the alarm device (306) for more critical alarms. The alarm generation component (328) may also cause notifications of alarms to be sent to monitoring personnel via email, a text message, a phone call, etc.

FIG. 4 shows a flow diagram of a method for detecting movement of a stationary video camera in accordance with one or more embodiments of the invention. The method may be performed in the stationary video camera and/or in a system receiving video sequences from the stationary video camera. Initially, a reference frame that is representative of the scene being monitored by the video camera is received (400). The reference frame may be, for example, a frame selected from the video sequence being captured by the video camera or a background model generated by video analytics processing in the video camera.

A reference spatial derivative image is then computed from the reference frame (402). The reference spatial derivative image may be computed as a spatial binary image as previously described herein in reference to FIG. 2. A frame, i.e., the current frame, of the video sequence being generated by the camera is then received (404) and a temporal derivative image is computed from that frame (406). The temporal derivative image may be computed as a temporal binary image by computing the pixel by pixel difference between the current frame and the immediately preceding frame of the video sequence and applying a threshold to the resulting pixel differences to produce a binary image in which pixels having a sufficiently large pixel difference are turned on and the remaining pixels are turned off. The temporal binary image may be computed as previously described herein in reference to FIG. 2.

The temporal derivative image is then compared to the spatial derivative image to determine if there is camera movement (408). For example, the temporal binary image may be compared to the spatial binary image to assess the pixel-wise match of on pixels between the two frames. A match score is then generated based on the number of matching on pixels. The match score may be generated as previously described herein in reference to FIG. 2. If the match score indicates that the video camera has been moved, then a movement notification is generated (410).

A check is then made to determine if the reference spatial derivative image should be updated (412). This check may be, for example, monitoring of an indication from video analytics processing in the video camera that the background model has been changed or determination that a predetermined period of time has passed since the current reference spatial derivative image was computed. If the check determines that the reference spatial derivative image should be updated, then processing continues with receiving a reference frame (400). Otherwise, if the video sequence has not ended (414), processing continues with computation of a temporal derivative image from the next frame in the video sequence (404).

FIG. 5 shows a flow diagram of a method for detecting movement of a stationary video camera and detecting cessation of the movement in accordance with one or more embodiments of the invention. The method may be performed in the stationary video camera and/or in a system receiving video sequences from the stationary video camera. Initially, a reference frame that is representative of the scene being monitored by the video camera is received (500). The reference frame may be, for example, a frame selected from the video sequence being captured by the video camera or a background model generated by video analytics processing in the video camera.

A reference spatial derivative image is then computed from the reference frame (502). The reference spatial derivative image may be computed as a spatial binary image as previously described herein in reference to FIG. 2. A frame, i.e., the current frame, of the video sequence being generated by the camera is then received (504) and a temporal derivative image is computed from that frame (506). The temporal derivative image may be computed as a temporal binary image by computing the pixel by pixel difference between the current frame and the immediately preceding frame of the video sequence and applying a threshold to the resulting pixel differences to produce a binary image in which pixels having a sufficiently large pixel difference are turned on and the remaining pixels are turned off. The temporal binary image may be computed as previously described herein in reference to FIG. 2.

The temporal derivative image is then compared to the reference spatial derivative image to determine if there is camera movement (508). For example, the temporal binary image may be compared to the reference spatial binary image to assess the pixel-wise match of on pixels between the two frames. A match score is then generated based on the number of matching on pixels. The match score may be generated as previously described herein in reference to FIG. 2. If the match score indicates that the video camera has been moved, then a movement notification is generated (508). The number of on pixels in the current temporal derivative image is also saved. A frame of the video sequence is then received (510) and a temporal derivative image is computed (518). A check is then made to determine if the movement of the video camera has stopped (520). This check is made by comparing the saved number of on pixels from the temporal derivative image at the time movement was detected to the number of on pixels in the current temporal derivative image. When the current number of on pixels is less than the saved number of on pixels, cessation of movement is detected. If movement has not stopped, processing continues with receiving another frame of the video sequence (516). If movement has stopped, a movement stopped notification is generated (522).

After movement stops or if no movement is detected, a check is then made to determine if the reference spatial derivative image should be updated (512). This check may be, for example, monitoring of an indication from video analytics processing in the video camera that the background model has been changed or determination that a predetermined period of time has passed since the current reference spatial derivative image was computed. If the check determines that the reference spatial derivative image should be updated, then processing continues with receiving a reference frame (500). Otherwise, if the video sequence has not ended (514), processing continues with computation of a temporal derivative image from the next frame in the video sequence (504).

The movement detection described herein may provide a low-cost implementation in terms of both computational and memory resources. For example, the computation for each incoming frame is done in a single pass. In some embodiments of the invention, on a per-frame basis, the computations are simple inter-frame pixel differences and determination of a number of on pixels that match between two binary images. Further, the edges for the reference spatial derivative image need not be computed for every frame. The movement detection is not affected by changes in the scene under surveillance caused by such things as illumination variance, large objects obscuring the camera, changes in focus, movement in the scene, etc. In addition, the cessation of movement detection as described herein enables filtering out of camera movement based on the duration of the movement. For example, a threshold movement tolerance may be set, and the movement notification triggered when the duration of the movement exceeds the threshold.

Embodiments of the methods described herein may be provided on any of several types of digital systems: digital signal processors (DSPs), general purpose programmable processors, application specific circuits, or systems on a chip (SoC) such as combinations of a DSP and a reduced instruction set (RISC) processor together with various specialized programmable accelerators. A stored program in an onboard or external (flash EEP) ROM or FRAM may be used to implement the video signal processing. Analog-to-digital converters and digital-to-analog converters provide coupling to the real world, modulators and demodulators (plus antennas for air interfaces) can provide coupling for transmission waveforms, and packetizers can provide formats for transmission over networks such as the Internet.

The methods described in this disclosure may be implemented in hardware, software, firmware, or any combination thereof. If implemented in software, the software may be executed in one or more processors, such as a microprocessor, application specific integrated circuit (ASIC), field programmable gate array (FPGA), or digital signal processor (DSP). The software that executes the techniques may be initially stored in a computer-readable medium and loaded and executed in the processor. In some cases, the software may also be sold in a computer program product, which includes the computer-readable medium and packaging materials for the computer-readable medium. Examples of computer-readable media include non-writable storage media such as read-only memory devices, writable storage media such as disks, memory, or a combination thereof.

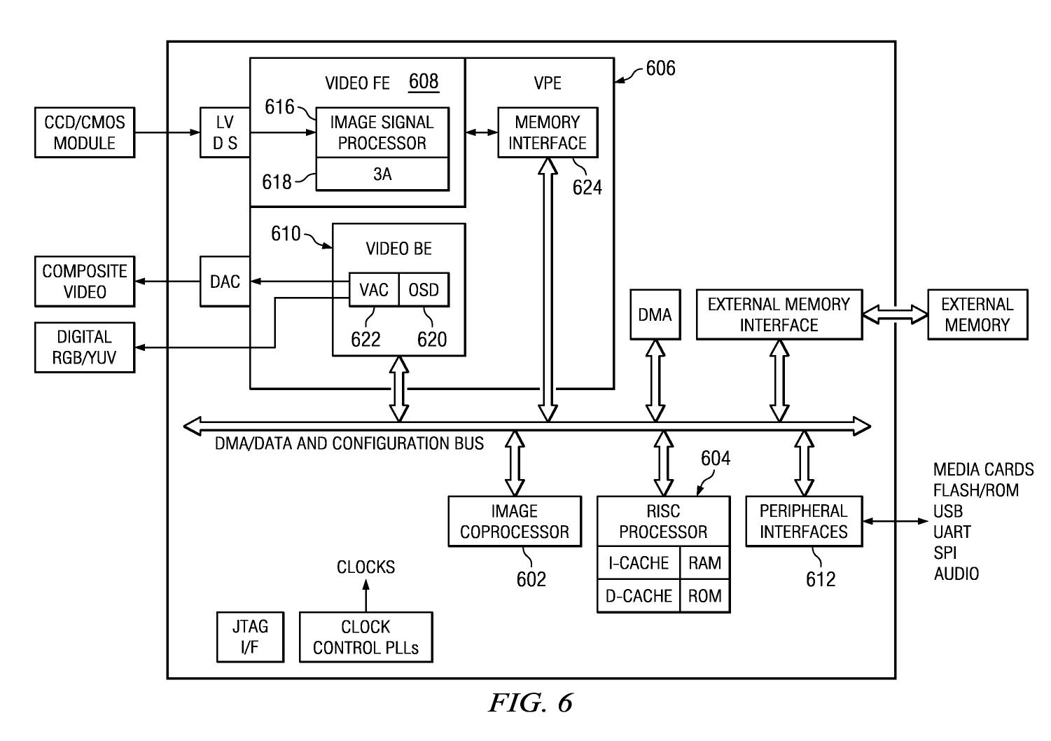

FIG. 6 shows a digital system suitable for use in a digital video camera in accordance with one or more embodiments of the invention. The digital system includes, among other components, a DSP-based image coprocessor (ICP) (602), a RISC processor (604), and a video processing engine (VPE) (606) that may be configured to perform one or more of the methods described herein. The RISC processor (604) may be any suitably configured RISC processor. The VPE (606) includes a configurable video processing front-end (Video FE) (608) input interface used for video capture from imaging peripherals such as image sensors, video decoders, etc., a configurable video processing back-end (Video BE) (610) output interface used for display devices such as SDTV displays, digital LCD panels, HDTV video encoders, etc, and memory interface (624) shared by the Video FE (608) and the Video BE (610). The digital system also includes peripheral interfaces (612) for various peripherals that may include a multi-media card, an audio serial port, a Universal Serial Bus (USB) controller, a serial port interface, etc.

The Video FE (608) includes an image signal processor (ISP) (616), and a 3A statistic generator (3A) (618). The ISP (616) provides an interface to image sensors and digital video sources. More specifically, the ISP (616) may accept raw image/video data from a sensor (CMOS or CCD) and can accept YUV video data in numerous formats. The ISP (616) also includes a parameterized image processing module with functionality to generate image data in a color format (e.g., RGB) from raw CCD/CMOS data. The ISP (616) is customizable for each sensor type and supports video frame rates for preview displays of captured digital images and for video recording modes. The ISP (616) also includes, among other functionality, an image resizer, statistics collection functionality, and a boundary signal calculator. The 3A module (618) includes functionality to support control loops for auto focus, auto white balance, and auto exposure by collecting metrics on the raw image data from the ISP (616) or external memory. In one or more embodiments of the invention, the Video FE (608) is configured to perform a method as described herein.

The Video BE (610) includes an on-screen display engine (OSD) (620) and a video analog encoder (VAC) (622). The OSD engine (620) includes functionality to manage display data in various formats for several different types of hardware display windows and it also handles gathering and blending of video data and display/bitmap data into a single display window before providing the data to the VAC (622) in YCbCr format. The VAC (622) includes functionality to take the display frame from the OSD engine (620) and format it into the desired output format and output signals required to interface to display devices. The VAC (622) may interface to composite NTSC/PAL video devices, S-Video devices, digital LCD devices, high-definition video encoders, DVI/HDMI devices, etc.

The memory interface (624) functions as the primary source and sink to modules in the Video FE (608) and the Video BE (610) that are requesting and/or transferring data to/from external memory. The memory interface (624) includes read and write buffers and arbitration logic.

The ICP (602) includes functionality to perform the computational operations required for compression and other processing of captured images. The video compression standards supported may include one or more of the JPEG standards, the MPEG standards, and the H.26x standards. In one or more embodiments of the invention, the ICP (602) is configured to perform the computational operations of methods as described herein.

In operation, to capture an image or video sequence, video signals are received by the video FE (608) and converted to the input format needed to perform video compression. Prior to the compression, a method(s) as described herein may be applied as part of processing the captured video data. The video data generated by the video FE (608) is stored in the external memory. The ICP can then read the video data and perform the necessary computations to perform methods as described herein. The video data is then processed based encoded, i.e., compressed. During the compression process, the video data is read from the external memory and the compression computations on this video data are performed by the ICP (602). The resulting compressed video data is stored in the external memory. The compressed video data may then read from the external memory, decoded, and post-processed by the video BE (610) to display the image/video sequence.

The RISC processor (604) may also includes functionality to perform the computational operations of methods as described herein. The RISC processor may read the video data stored in external memory by the video FE (608) and can perform the required computations and store the output back in external memory.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims. It is therefore contemplated that the appended claims will cover any such modifications of the embodiments as fall within the true scope and spirit of the invention.

What is claimed is:

1. A method of detecting movement of a video camera, the method comprising:
computing a reference spatial derivative image from a reference frame;
computing a temporal derivative image based on two frames of a video sequence captured by the video camera; and
determining whether the video camera has moved based on a number of pixels in the temporal derivative image that match pixels in the reference spatial derivative image.

2. The method of claim 1, wherein computing a reference spatial derivative image comprises computing a reference binary image from the reference frame, and computing the temporal derivative image comprises computing a temporal binary image based on the two frames.

3. The method of claim 2, wherein computing a reference binary image comprises performing edge detection on the reference frame, and computing a temporal binary image comprises computing a pixel difference between each pixel in a first frame of the two frames and a corresponding pixel in a second frame of the two frames.

4. The method of claim 1, wherein the reference frame is one selected from a group consisting of a background model and a frame selected from the video sequence.

5. The method of claim 1, further comprising:
receiving a new reference frame; and
computing the reference spatial derivative image from the new reference frame.

6. The method of claim 2, wherein determining whether the video camera has moved comprises computing a match score based on a number of matching on pixels between the reference binary image and the temporal binary image and a number of on pixels in the temporal binary image.

7. The method of claim 6, wherein computing a match score comprises computing an F-measure score as 2PR/(P+R), wherein P is the number of matching on pixels divided by the number of on pixels in the temporal binary image and R is the number of matching on pixels divided by a number of on pixels in the reference binary image.

8. The method of claim 7, wherein the match score is computed as a function of the F-measure, R, and P.

9. The method of claim 2, further comprising determining that the video camera has stopped moving when a number of on pixels in a temporal binary image computed after movement of the video camera is determined is less than a number of on pixels of a temporal binary image used to determine the movement.

10. The method of claim 1, wherein computing a reference spatial derivative image, computing a temporal derivative image, and determining whether the video camera has moved are performed in the video camera.

11. A digital system comprising:
means for computing a reference spatial derivative image from a reference frame;
means for computing a temporal derivative image based on two frames of a video sequence captured by a video camera; and
means for determining whether the video camera has moved based on a number of pixels in the temporal derivative image that match pixels in the reference spatial derivative image.

12. The digital system of claim 11, wherein the means for computing a reference spatial derivative image comprises means for computing a reference binary image from the reference frame, and the means for computing the temporal derivative image comprises means for computing a temporal binary image based on the two frames.

13. The digital system of claim 11, wherein the reference frame is one selected from a group consisting of a background model and a frame selected from the video sequence.

14. The digital system of claim 11, further comprising:
means for receiving a new reference frame; and
means for computing the reference spatial derivative image from the new reference frame.

15. The digital system of claim 12, wherein the means for computing a reference binary image comprises performs edge detection on the reference frame, and the means for computing a temporal binary image computes a pixel difference between each pixel in the frame and a corresponding pixel in a previous frame of the video sequence.

16. The digital system of claim 12, wherein the means for determining whether the video camera has moved comprises means for computing a match score based on a number of matching on pixels between the reference binary image and the temporal binary image and a number of on pixels in the temporal binary image.

17. The digital system of claim 16, wherein the means for computing a match score computes an F-measure score as 2PR/(P+R), wherein P is the number of matching on pixels divided by the number of on pixels in the temporal binary image and R is the number of matching on pixels divided by a number of on pixels in the reference binary image.

18. The digital system of claim 17, wherein the match score is computed as a function of the F-measure, R, and P.

19. The digital system of claim 12, further comprising:
means for determining that the video camera has stopped moving when a number of on pixels in a temporal binary image computed after movement of the video camera is determined is less than a number of on pixels of a temporal binary image used to determine the movement.

20. The digital system of claim 11, wherein the digital system is the video camera.
